(19) United States
(12) Patent Application Publication
(10) Pub. No.: US 2025/0231079 A1
(43) Pub. Date: Jul. 17, 2025

(54) PERFORMING DEFORMATION ANALYSIS OF A WIND TURBINE BLADE

(71) Applicant: Siemens Gamesa Renewable Energy A/S, Brande (DK)

(72) Inventors: Philippe Couturier, Lafayette, CO (US); David Molitor, Boulder, CO (US)

(21) Appl. No.: 18/411,283

(22) Filed: Jan. 12, 2024

(51) Int. Cl. G01M 5/00; F03D 17/00

(52) U.S. Cl. CPC G01M 5/0041; F03D 17/022; F03D 17/028; G01M 5/0025; F05B 2260/83

(57) ABSTRACT

It is described a method of performing deformation and/or orientation analysis of a wind turbine rotor blade, the method comprising: acquiring first position data of a first navigation system probe mounted at the blade to provide position at a first location; acquiring second position data of a second navigation system probe mounted at the blade to provide position at a second location; deriving first direction information at least regarding a relative direction of the first location and the second location based on the first position data and the second position data.

### FIELD OF TECHNOLOGY

The present invention relates to a method of performing deformation and/or orientation analysis of a wind turbine rotor blade. Further, the present invention relates to a device for performing deformation and/or orientation analysis of a wind turbine rotor blade and further relates to a rotor blade system.

### BACKGROUND

Rotor blades of a wind turbine nowadays may have a substantive length, they may be slender and flexible such that the rotor blade tip may experience deflections and deformations of dozens of metres and the rotor blade may experience a twist of multiple degrees. Accordingly, the rotor blade airfoils and their orientation used to build the blade outer geometry may be designed such that the optimal performance of such a blade is achieved in this deformation state, not in the undeformed state. The process of defining or setting up the optimal geometry and/or constructional constitution of the wind turbine blade may also be referred to as aeroelastic tailoring of the rotor blade (ATB). If the aeroelastic tailoring is done in or comprising errors, significant performance loss may be observed. Therefore, it may be imperative to have a robust validation procedure for the aeroelastic tailoring signature when prototyping a new wind turbine design or type.

Conventionally, deformation analysis or aeroelastic tailoring analysis of a wind turbine blade has been performed using an optical method, wherein a camera is mounted to the suction side root of the blade and oriented such that the aperture is facing the blade tip. When the rotor blade deforms, the rotor blade tip may come into the field of view of the camera. Additionally, a “target” may be placed at the blade tip on which the camera may focus. The target's position can then be calculated using an image processing algorithm.

It has however been observed and experienced that conventional methods for deformation analysis or dynamic aeroelastic tailoring of a rotor blade are not in all circumstances or conditions satisfactory in terms of accuracy and/or reliability and ease to use or to perform.

Thus, there may be a need for a method of performing deformation and/or orientation analysis of a wind turbine rotor blade, wherein disadvantages of the conventional methods are at least mitigated and in particular wherein the blade deformation and/or orientation at different operational states may be assessed or measured. Furthermore, it may be desired to provide a method of performing deformation and/or orientation analysis and/or assessment, which can be performed at different environmental conditions and in different environments, such as at an installation site or at a test installation location.

### SUMMARY

This need may be met by the subject matter according to the independent claims. Advantageous embodiments of the present invention are described by the dependent claims.

According to an embodiment of the present invention it is provided a method of performing deformation and/or orientation analysis of a wind turbine rotor blade, the method comprising: acquiring first position data of a first navigation system probe mounted at the blade to provide position at a first location (e.g. relative to the blade); acquiring second position data of a second navigation system probe mounted at the blade to provide position at a second location (e.g. relative to the blade); deriving first direction information at least regarding a relative direction of the first location and the second location based on the first position data and the second position data.

The method may partly be implemented in software and/or hardware. The method may for example partly be carried out or controlled by a processing system or computer system.

A deformation of the wind turbine rotor blade may relate or may mean a change of the shape of the rotor blade as experienced during different operational conditions of the rotor blade. The deformation/orientation analysis of the rotor blade may relate to a change of the shape, for example involving also a twist of the rotor blade during different operational conditions. During different operational states, the rotor blade may bend and/or twist in different directions, wherein the degree of bending and/or degree of twist and/or degree of deformation and/or orientation change of portions of the rotor blade may be determined or assessed according to embodiments of the present invention.

The method may be performed during one or more operational states or operational conditions of the rotor blade including states where a rotor at which the rotor blade is mounted is rotating or including situations when the rotor is not rotating or substantially standing still.

The first and/or the second position data which are acquired may then be recorded or stored at a suitable recording medium, either at the first navigation system probe and/or the second navigation system probe or the respective data may be transmitted to a processing system comprising also storage capabilities, wherein the respective position data may be stored at an electronic storage of the processing system. According to one embodiment, the respective first and/or second position data are acquired for a particular operational condition and operation timespan and recorded locally. The position data locally recorded and stored at the first/second navigation system probe may be transferred to a processing or analysis computing system for processing and assessment.

The first and/or the second navigation system probe may comprise equipment for probing (e.g. measuring or acquiring or determining) their respective (global) positions. The first and/or the second navigation system probe may comprise or may be or may be configured as a GNSS sensor.

Both the first and/or the second navigation system probe are mounted at the blade. Each navigation system probe has associated a location for which the respective position is determined. The first navigation system probe provides position data which relate to the first location which may be a location relative to the blade which is predetermined or preknown. The second navigation system probe is mounted at the blade such as to provide position at the second location (relative to the blade). Thus, the first location and the second location are preknown locations relative to (for example any reference point on) the blade. Thus, having acquired and/or having access to the first position data and the second position data indicating where the first location and the second location are positioned, may allow to determine the respective positional constitution of the rotor blade in the spatial region where the first navigation system probe and the second navigation system probe are mounted.

The first direction information may indicate in which direction the second location can be reached starting from the first location. The first direction information may therefore provide valuable information regarding deformation and/or orientation of portions of the wind turbine rotor blade. Thereby, deformation and/or orientation analysis of the rotor blade may be improved.

It should be noted that the method may be performed on a test stand or at a customer site.

According to an embodiment of the present invention, the first location and the second location are arranged at radial positions that deviate less than 1/10 or 1/20 or 1/50 of a longitudinal extent of the rotor blade along a beam reference line of the blade from a predefined (first) radial position; and/or wherein the first location and the second location have a distance closer than between 1/10 or 1/20 or 1/50 of a longitudinal extent of the rotor blade along a beam reference line of the blade from a first cross-sectional plane being perpendicular to a beam reference line of the blade.

The beam reference line of the blade may represent a (e.g. curved) line (e.g. running substantially in a longitudinal direction of the blade, e.g. middle longitudinal axis of the blade) outlining the curvature and/or shape of the airfoil. Cross-section plane of the blade may be defined to be locally perpendicular to the beam reference line.

The beam reference line of the blade may be a representative line outlining the placement and curvature of the constitutive airfoils.

The respective radial position may be a distance from a rotational axis of a rotor at which the rotor blade is connected to the respective first or second location. The first and second location may have substantially same radial positions. Therefore, the first and second locations may substantially lie in one cross-sectional plane, i.e., the first cross-sectional plane. When the first and second locations substantially lie in the first cross-sectional plane (or having a relatively small distance to this first cross-sectional plane), the respective first position data and second position data may advantageously provide information from which the deformation and/or orientation of the rotor blade may be derived.

From the first direction information and in particular further information regarding position and/or orientation of a root section of the rotor blade, the degree of deformation and/or orientation (e.g. of a difference vector between the first location of the second location) and/or degree of twist and direction of twist may be derived.

According to an embodiment of the present invention, the first location and the second location substantially are arranged within a first cross-sectional plane or substantially at a predefined first radial position.

Thereby, advantageously, deformation and/or orientation and/or deflection characteristics of the wind turbine rotor blade may be determined in an easy and reliable manner.

According to an embodiment of the present invention, the method further comprises deriving first orientation information (e.g. of a difference vector between the first location of the second location) and/or regarding a three-dimensional orientation of the first cross-sectional plane based on the first position data and the second position data and/or based on the relative direction of the first location and the second location.

Embodiments may allow to derive the orientation of the first cross-sectional plane and/or a difference vector between the first location of the second location from the first position data and second position data and in particular further position data. The first orientation information may advantageously allow to thoroughly assess or determine the deformation and/or deflection and/or orientation and twisting characteristics of the wind turbine blade.

According to an embodiment of the present invention, the first and/or second probe comprises a respective antenna and a receiver and/or processing circuitry, in particular configured for transformation to a blade reference frame and/or tip orientation determination, and/or a recording medium, wherein the first and/or second location is a location within the antenna of the respective probe, wherein the respective antenna in particular protrudes from a suction side or from a pressure side surface of blade.

The first and/or second location may be at defined positions within (or close to) the respective antenna of the respective probe which defined position may be preknown. Further, the relative position of the respective probe relative to the blade (e.g. a reference point) may be preknown. From the preknown relative positionings from the first position data and the second position data, respective positions in a rotor blade fixed reference frame may be derived.

The accuracy of the measurements may have an error for example less than 2 cm or less than 1 cm or between 2 cm and 0.5 cm. Thereby, accurate deformation and/or orientation and/or twisting analysis of the wind turbine rotor blade may be performed.

According to an embodiment of the present invention, the antenna of the first probe may protrude from the pressure side and/or the antenna of the second probe may protrude from the suction side. Thereby, the accuracy of the first direction information may be improved.

According to an embodiment of the present invention, the first and/or second position data comprises at least one of: an absolute geographical position; a three-dimensional position of a reference frame fixed to the earth; a geoposition related to a geostationary coordinate frame.

The first and/or second position data may relate to positions as provided by a global navigation satellite system which may provide position data relating to a geostationary reference frame. From this geostationary coordinate frame, embodiments of the present invention may transform to any other suitable reference frame, for example a reference frame which is fixed relative to the rotor blade. In this rotor blade fix reference frame, the initial geometry or design of the rotor blade may be known. Any deviation of the initial or original design or shape of the rotor blade may simply and easily be determined in the rotor blade fixed reference frame.

It should be understood that the first and the second navigation system probe may commonly or together be fixed at a first mounting member or mounting system. The first mounting system may be configured to mount the first as well as the second navigation system probe at the blade.

According to an embodiment of the present invention, the method further comprises acquiring third position data of a third navigation system probe mounted at the blade to provide position at a third location; acquiring fourth position data of a fourth navigation system probe mounted at the blade to provide position at a fourth location; deriving second direction information at least regarding a relative direction of the third location and the fourth location based on the third position data and the fourth position data, wherein the third location and the fourth location have a distance smaller than between 10 m and 0.5 m from a (second) cross-sectional plane, in particular spaced apart from the first cross-sectional plane by more the 0.5 times a longitudinal extent of the blade.

According to an embodiment of the present invention, the method further comprises acquiring still further position data of one of more further navigation system probes mounted at the blade to provide position at different locations. Those further position data may also be considered for deformation and/or orientation analysis.

A second mounting system may have fixed thereon the third and the fourth navigation system probe and may allow to mount the third and the fourth navigation system probe together at the wind turbine blade. Thereby, mounting of the several navigation system probes may be simplified. Furthermore, advantageously, respectively the first and second and the third and fourth navigation system probes can substantially be mounted such that their respective antenna positions are substantially in a same first/second cross-sectional plane. Thus, providing first, second, third and fourth navigation probes may allow to determine the first direction information as well as the second direction information from which a deformation and/or orientation (change) and/or deflection change and/or twist of the rotor blade may be derived.

According to further embodiments, still more navigation system probes may be mounted at the rotor blade and also those additional navigation system probes may acquire further position data which may be considered for performing the deformation and/or orientation analysis of the blade. For example, for one or more cross-sectional planes, a triple of navigation system probes may be provided which is substantially located or arranged in the respective cross-sectional plane.

According to an embodiment of the present invention, the method further comprises deriving second orientation information regarding a three-dimensional orientation of the second cross-sectional plane based on the third position data and the fourth position data and/or based on the relative direction of the third location and the fourth location.

The second orientation information may be indicative of the orientation of the second cross-sectional plane. Together with the first orientation information, the second orientation information may be considered for performing the deformation and/or orientation analysis of the rotor blade. E.g. a deviation of the orientation of the first cross-sectional plane from the orientation of the second cross-sectional plane may be determined for performing the deformation and/or orientation analysis of the rotor blade.

According to an embodiment of the present invention, the method further comprises deriving deformation and/or orientation characteristics of wind turbine rotor blade, including in particular blade tip deflection and/or blade rotation and/or aeroelastic tailoring validation/assessment of the blade and/or blade coning and/or tower tilt and/or blade twist, based on the first and/or second orientation information and/or based on the first position data and the second position data and/or based on the third position data and the fourth position data.

According to an embodiment of the present invention the method is performed on a wind turbine blade not connected to a hub of a wind turbine, in particular on a testing-facility or teststand, in particular for performing fatigue analysis.

Thereby, a thorough shape or deformation or deflection or twisting analysis of the wind turbine blade may be performed.

According to an embodiment of the present invention, the first and/or second and/or third and/or fourth probe is reversibly mounted at the blade, in particular using a mounting bracket surrounding the blade in cross section, in particular using press fit and/or form fit and/or compression fit.

When the respective probes are reversibly mounted at the blade, the deformation and/or orientation analysis may be needed only to be performed for example at a test side and the respective probes may be dismounted or demounted for setting up the blades and rotor or wind turbine for the normal production at a customer installation site.

The mounting brackets or mounting members utilized may have different design and constitutions according to different embodiments. According to one embodiment, a mounting bracket may engage and/or substantially surround an entire circumferential extent of the rotor blade for example substantially at one cross-sectional plane or cross-sectional region. Mounting the respective probes at the blade may not require to provide any through-holes through a blade wall and may not require to screw bolts through the through-holes in the rotor blade wall. Thereby, damaging a rotor blade wall may be avoided.

According to an embodiment of the present invention, the first and/or second and/or third and/or fourth probe is irreversibly mounted at the blade, in particular embedded such that the antenna is exposed to the environment.

An irreversibly mounted probe may therefore advantageously be utilized for tests also at an energy production installation site, such that deformation analysis and orientation analysis can also be performed on the customer installation site, for example in order to validate any prior assessments or analyses.

According to an embodiment of the present invention, a control method for controlling the wind turbine is provided, wherein the first and/or second and/or further position data may be supplied to a controller for controlling the wind turbine based on the first and/or second and/or further position data.

According to an embodiment of the present invention, the first and/or second and/or third and/or fourth navigation system probe performs at least one of: receiving radio signals from one or more satellites including at least a time stamp, comparing a time stamp received from a satellite with an arrival time; deriving time of flight and/or distance to one of more satellites, wherein the first and/or second and/or third and/or fourth navigation system probe in particular uses a global navigation satellite system (GNSS), in particular GPS, or Galileo.

Thereby, conventionally available navigation systems may be utilized. Nowadays, the accuracy of such global navigation satellite systems may be better than 1 cm, thereby providing accurate deformation and/or orientation analysis of a rotor blade.

According to an embodiment of the present invention, performed at different operational states of the wind turbine, including at least one of: stand-still, normal operation while rotor is rotating, maintenance, emergency stop.

Thereby, the deformation and/or orientation characteristics of the rotor blade may thoroughly be determined or assessed, in particular for all relevant operational conditions which may be experienced during a lifetime of the wind turbine blade.

It should be understood, that features, individually or in any combination, disclosed, described, applied or provided for a method of performing deformation and/or orientation analysis may also, individually or in any combination, be applied or provided for a device for performing deformation and/or orientation analysis according to embodiments of the present invention and vice versa.

According to an embodiment of the present invention it is provided a device for performing deformation and/or orientation analysis of a wind turbine rotor blade, the device comprising: a mounting frame to be (e.g. reversibly) mounted at a wind turbine blade; a first navigation system probe fixed to the mounting frame; in particular a second navigation system probe fixed to the mounting frame; wherein when the mounting frame is mounted at the blade: the first navigation system probe provides position at a first location; the second navigation system probe provides position at a second location.

The device may be utilized for performing a method of performing deformation and/or orientation analysis according to embodiments of the present invention.

The mounting frame (or one of more further mounting frame(s)) may also have mounted thereon a third navigation system probe or even still more navigation system probes. Thereby, performing a method according to embodiments may be simplified using the device.

According to an embodiment of the present invention it is provided a rotor blade system, comprising: a rotor blade for a wind turbine; a device according to the preceding embodiment, mounted at the rotor blade.

Furthermore, according to an embodiment, a wind turbine is provided comprising at least one rotor blade system as described in the preceding embodiment.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

### BRIEF DESCRIPTION

Embodiments of the present invention are now described with reference to the accompanying drawings. The invention is not restricted to the illustrated or described embodiments.

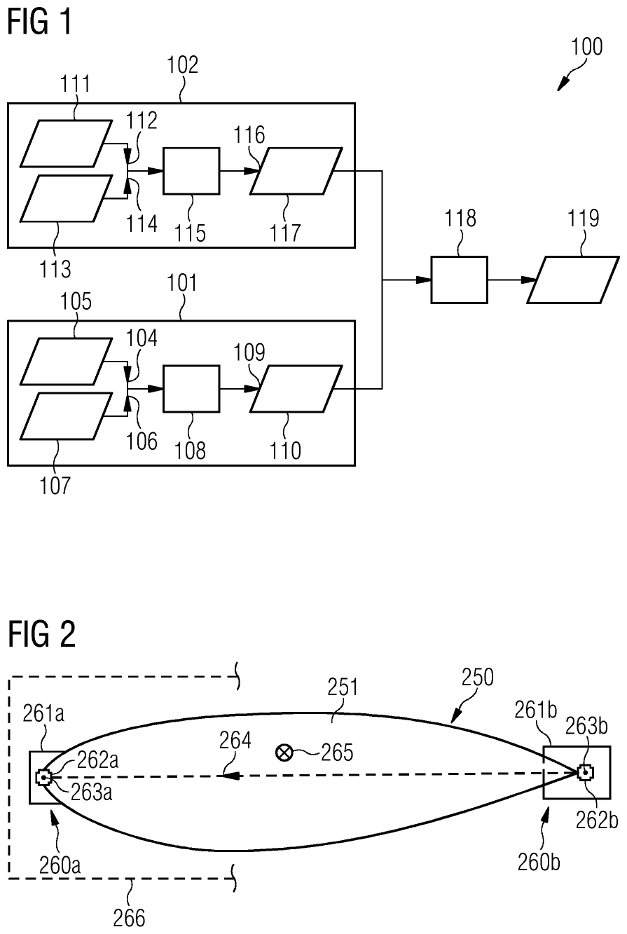

FIG. 1 schematically illustrates a method or system scheme of a method for performing a deformation and/or orientation analysis of a wind turbine rotor blade according to an embodiment of the present invention;

FIG. 2 schematically illustrates in a cross-sectional view a rotor blade system according to an embodiment of the present invention;

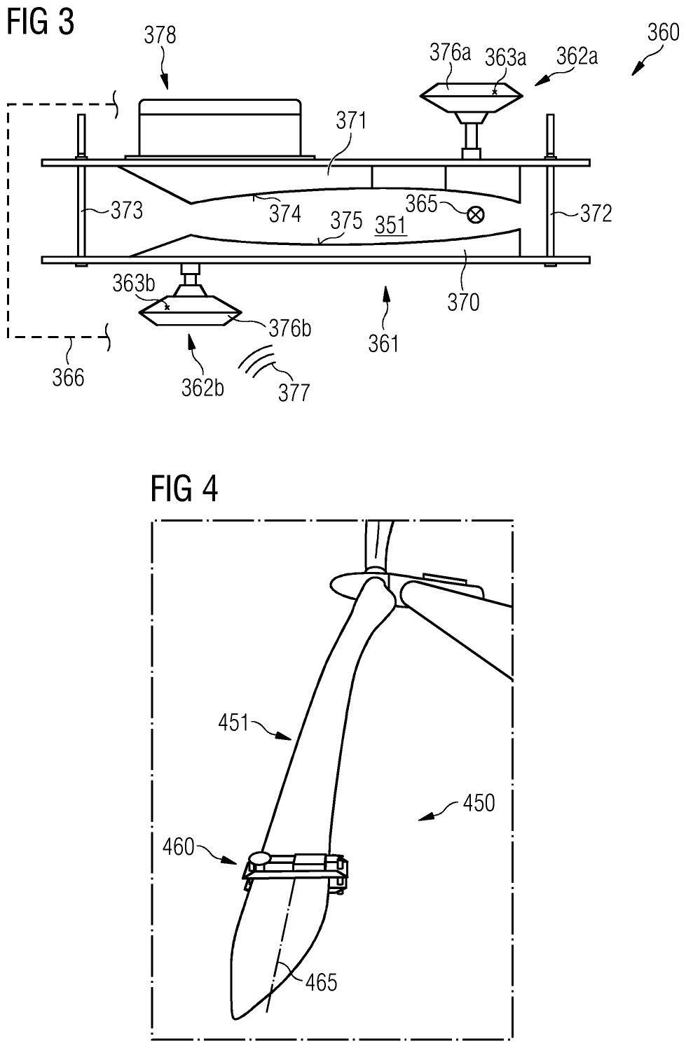

FIG. 3 schematically illustrates a device for performing deformation and/or orientation analysis of a wind turbine rotor blade according to an embodiment of the present invention; and

FIG. 4 schematically illustrates a wind turbine system according to an embodiment of the present invention.

### DETAILED DESCRIPTION

The illustration in the drawings is in schematic form. It is noted that in different figures, elements similar or identical in structure and/or function are provided with the same reference signs or with reference signs, which differ only within the first digit. A description of an element not described in one embodiment may be taken from a description of this element with respect to another embodiment.

The method or system scheme 100 of a method of performing deformation and/or orientation analysis of a wind turbine rotor blade according to an embodiment of the present invention illustrated in FIG. 1 comprises position data acquisitions within a first global navigation satellite system (GNSS) unit 101 and data acquisition in a second GNSS unit 102. According to other embodiments of the present invention, only one GNSS unit (i.e., 101 or 102) acquires position data. In further embodiments, more than two GNSS units may require position data.

The first global navigation satellite system (GNSS) unit 101 comprises a first navigation system probe 105 and second navigation system probe 107. The first navigation system probe 105 which is mounted at the blade to provide position at a first location relative to the blade acquires or outputs first position data 104. Furthermore, second position data 106 are acquired by a second navigation system probe 107 which is also mounted at the blade to provide position at a second location relative to the blade are acquired. In a processing block 108, first direction information at least regarding a relative direction of the first location and the second location based on the first position data and the second position data is derived.

FIG. 2 illustrates in a schematic cross-sectional view a wind turbine blade system 250 according to an embodiment of the present invention. The rotor blade system 250 comprises a rotor blade 251 as well as a device 260 comprised of device portions 260a, 260b for performing deformation and/or orientation analysis according to an embodiment of the present invention. The device 260 comprising device portions 260a, 260b comprises a mounting frame 261a, 261b to be reversibly mounted at the wind turbine blade 251. The device 260a, 260b further comprises a first navigation system probe 262a fixed to the mounting frame 260a and in particular a second navigation system probe 262b which is mounted to the mounting frame 261b (the mounting frame portions 261a,b forming a mounting frame 261). Therein, the mounting frame 261a, 261b is mounted at the blade 251. The first navigation system probe 262a provides position at a first location 263a and the second navigation system probe 262b provides position at a second location 263b.

Referring again to FIG. 1, first navigation system probe 105 and the second navigation system probe 107 may be configured and/or mounted as the first navigation system probe 262a and the second navigation system probe 262b illustrated in FIG. 2.

In FIG. 1, the processing block 108 may determine first direction information which may indicate the direction 264 (see FIG. 2) regarding a relative direction of the first location 263a and the second location 263b which is derived based on the first position data 104 and the second position data 106. Thus, according to embodiments of the present invention, the first navigation system probe 105 illustrated in FIG. 1 may be implemented by the first navigation system probe 262a illustrated in FIG. 2 and the second navigation system probe 107 of FIG. 1 may be implemented as the second navigation system probe 263b illustrated in FIG. 2.

It is noted that the view of FIG. 2 represents a cross-sectional view of the rotor blade 251 substantially perpendicular to a beam reference line 265 of the rotor blade 251. As can be appreciated from FIG. 2, the first location 262a and the second location 263b are substantially in the same cross-sectional plane 266 (i.e. the drawing plane of FIG. 2) being perpendicular to the beam reference line 265 of the blade. In other embodiments, the first and second locations may slightly deviate from the respective first cross-sectional plane 266, as has been explained above. It should also be noted that the beam reference line 265 substantially may be (e.g. at a root section) aligned or coincident with a radial direction (being perpendicular to a rotation axis of a rotor at which the rotor blade 251 is mounted). Thus, the first location 263a and the second location 263b may be at substantially same radial positions.

According to a further embodiment of the present invention, the processing block 108 illustrated in FIG. 1 may derive, in a block 110, first orientation information 109 regarding a three-dimensional orientation of the first cross-sectional plane 266 based on the first position data 104 and the second position data 106 and/or based on the relative direction 264 of the first location 263a and the second location 263b.

In method block or system block 110, the tip section orientation in a global coordinate system is stored or calculated.

According to an embodiment of the present invention, the method or the processing system 100 may further comprise to acquire position data by the second GNSS unit 102 which may for example be arranged or installed or mounted closer to a root portion of the rotor blade. Thereby, a third navigation system probe 111 (included in unit 102) acquires third position data 112, wherein the third navigation system probe 111 is mounted at the blade. Furthermore, a fourth navigation system probe 113 acquires fourth position data 114, wherein the fourth navigation system probe 113 is mounted at the blade to provide position at a fourth location.

It may be understood, that the third location and the fourth location may similarly as the first location 263a, and second location 263b be substantially arranged at a second cross-sectional plane which may for example be spaced apart from the cross-sectional plane 266 illustrated in FIG. 2. Similarly as the first GNSS unit 101, in a processing block of the second GNSS unit 102 labelled with reference sign 115, a second direction information at least regarding a relative direction of the third location and the fourth location may be calculated. According to other embodiments, a blade section orientation calculator 115 calculates second orientation information 116 regarding a three-dimensional orientation of the second cross-sectional plane (within which for example the third location and the fourth location are arranged).

In the block 117, the root section orientation in a global coordinate system is calculated or stored.

The tip section orientation in the global coordinate system from block 110 as well as the root section orientation in the global coordinate system from block 117 are together provided by a coordinate system transformation block 118 according to embodiments of the present invention. The transformation block 118 may transform into a blade fixed coordinate system thereby providing the tip section orientation in the blade coordinate system in the block 119.

According to an embodiment of the present invention, at least two global navigation satellite system (GNSS) units or probes mounted at a predefined radial position on a wind turbine blade are utilized in order to conduct deformation and/or orientation analysis or aeroelastic tailoring of a rotor blade and/or validation. Using the instantaneous absolute position recorded at the same cross-section by a plurality of GNSS units, the line or a plane in a three-dimensional space may be generated, as is for example illustrated in FIG. 2 by the direction 264 and the respective cross-sectional plane 266.

FIG. 3 schematically illustrates a device 360 for performing deformation and/or orientation analysis of a wind turbine rotor blade according to an embodiment of the present invention. The device 360 comprises a mounting frame 361 comprising a pressure side portion 370 and a suction side portion 371. The pressure side portion 270 is substantially complementary to a pressure side surface portion of the rotor blade and the suction side portion 371 is substantially complementary to a suction side portion of a rotor blade outer airfoil portion. The mounting member 361 is configured substantially as a mounting bracket which may involve or surround a surface of a blade cross-section. Thus, the blade 351 would be surrounded by the mounting frame portions 370, 371. Dowel pins 372, 373 may hold the mounting frame portions 370, 371 together and press them with their surfaces 374, 375 towards the rotor blade 351.

The device 360 comprises a first navigation system probe 362a and a second navigation system probe 362b. The first navigation system probe 362a comprises a first antenna 376a and the second navigation system probe 362b comprises a second antenna 376b which receive satellite signals 377 from one or more satellites. The device 360 further comprises a receiver and a processing circuitry 378 which receives the positional information derived by the antennas 376a, 376b from the satellite signals 377. Within the first antenna 376a, the first location 363a is indicated, within the second antenna 376b the second location 363b is indicated. The relative orientation or positions of those first and second locations 363a, 363b are preknown in a coordinate system for example fixed to the rotor blade 351. The first and second position data acquired by the first and second antennas 376a,b relate to the geopositions of the first location 363a and the second location 363b, respectively.

According to embodiments of the present invention, a GNSS unit may comprise the combination of a GNSS receiver and antenna which can take a direct measurement of its absolute position within a tolerance of for example 1 cm or better than 1 cm. In the embodiment illustrated in FIG. 1, blade tip rotation may be calculated in the blade reference frame using the GNSS units mounted at the blade tip and the blade root.

FIG. 4 schematically illustrates a rotor blade system 450 according to an embodiment of the present invention comprising a rotor blade 451 and a device 460 for performing deformation and/or orientation analysis of a wind turbine rotor blade according to an embodiment of the present invention. The device 460 may for example similarly be constructed as the device 360 illustrated in FIG. 3. According to other embodiments of the present invention, the device may be differently designed or constructed. The device 360 may reversibly be mounted at a rotor blade and may be demounted when not required any more.

It is also possible to embed at least the antennas of the respective GNSS units within the rotor blade in a permanent manner.

Embodiments of the present invention may have one or more of the following advantages and/or features:
Capture blade orientation at all operational states, not just when the tip is in view of the (conventional) camera
Captures global position information of the blade which can be used for absolute validation comparisons, i.e., includes tower tilt and blade coning
GNSS may capture the third dimension, while a conventional camera may only capture two dimensional measurements. This may lead to validation of “cant” and “toe” angles as well as twist.
Multiple sensors may be placed at many spanwise locations of the blade. The optical system may only be focused on a single target.
The system or method may be used in adverse weather or in general adverse environmental conditions, while an unobstructed line of site may be necessary for the conventional optical system.
The device can be left for an extended period of time on the blade while the camera and templates can interfere with other test and as such must be taken down.
System may be useful at any site. Embodiments of the present invention may be useful with any wind turbine site. In contrast, a conventional optical system may rely on the background of the photographs to be distinct from the tip target.
Flexible mounting positions of the navigations probes. GNSS sensors may be placed anywhere at the root or tip while a conventional camera and tip target must be placed at very specific locations.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

1. A method of performing deformation and/or orientation analysis of a wind turbine rotor blade, the method comprising:
acquiring first position data of a first navigation system probe mounted at the blade to provide position at a first location;
acquiring second position data of a second navigation system probe mounted at the blade to provide position at a second location;
deriving first direction information at least regarding a relative direction of the first location and the second location based on the first position data and the second position data.

2. The method according to claim 1,
wherein the first location and the second location are arranged at radial positions that deviate less than 1/10 or 1/20 or 1/50 of a longitudinal extent of the rotor blade along a beam reference line of the blade from a predefined (first) radial position; and/or
wherein the first location and the second location have a distance closer than between 1/10 or 1/20 or 1/50 of a longitudinal extent of the rotor blade along a beam reference line of the blade from a first cross-sectional plane being perpendicular to the beam reference line of the blade.

3. The method according to claim 1,
wherein the first location and the second location substantially are arranged within a first cross-sectional plane or substantially at a predefined first radial position.

4. The method according to claim 1, further comprising:
deriving first orientation information regarding a three dimensional orientation of the first cross-sectional plane based on the first position data and the second position data and/or based on the relative direction of the first location and the second location.

5. The method according to claim 1,
wherein the first and/or second probe comprises a respective antenna and a receiver and/or processing circuitry, in particular configured for transformation to a blade reference frame and/or tip orientation determination, and/or a recording medium,
wherein the first and/or second location is a location within the antenna of the respective probe,
wherein the respective antenna in particular protrudes from a suction side or from a pressure side surface of blade.

6. The method according to claim 1,
wherein the first and/or second position data comprises at least one or:
an absolute geographical position;
a three dimensional position of a reference frame fixed to the earth;
a geoposition related to a geostationary coordinate frame.

7. The method according to claim 1, further comprising:
acquiring third position data of a third navigation system probe mounted at the blade to provide position at a third location;
acquiring fourth position data of a fourth navigation system probe mounted at the blade to provide position at a fourth location;
deriving second direction information at least regarding a relative direction of the third location and the fourth location based on the third position data and the fourth position data,
wherein the third location and the fourth location have a distance smaller than between 10 m and 0.5 m from a second cross-sectional plane, in particular spaced apart from the first cross-sectional plane by more the 0.5 times a longitudinal extent of the blade.

8. The method according to claim 1, further comprising:
deriving second orientation information regarding a three dimensional orientation of the second cross-sectional plane based on the third position data and the fourth position data and/or based on the relative direction of the third location and the fourth location.

9. The method according to claim 1, further comprising:
deriving deformation and/or orientation characteristics of wind turbine rotor blade, including in particular blade tip deflection and/or blade rotation and/or aeroelastic tailoring validation/assessment of the blade and/or blade coning and/or tower tilt and/or blade twist, based on the first and/or second orientation information and/or based on the first position data and the second position data and/or based on the third position data and the fourth position data; and/or
wherein the method is performed on a wind turbine blade not connected to a hub of a wind turbine, in particular on a testing-facility or test stand, in particular for performing fatigue analysis.

10. The method according to claim 1,
wherein the first and/or second and/or third and/or fourth probe is reversibly mounted at the blade, in particular using a mounting bracket surrounding the blade in cross section,
in particular using press fit and/or form fit and/or compression fit, or
wherein the first and/or second and/or third and/or fourth probe is irreversibly mounted at the blade, in particular embedded such that the antenna is exposed to the environment.

11. The method according to claim 1, wherein the first and/or second and/or third and/or fourth navigation system probe performs at least one of:
receiving radio signals form one or more satellites including at least a time stamp,
comparing a time stamp received from a satellite with an arrival time;
deriving time of flight and/or distance to one of more satellites,
wherein the first and/or second and/or third and/or fourth navigation system probe in particular uses a global navigation satellite system, in particular GPS, or Galileo.

12. The method according to claim 1, performed at different operational states of the wind turbine, including at least one of:
stand-still, normal operation while rotor is rotating, maintenance, emergency stop.

13. The method for controlling a wind turbine, comprising:
performing a method according to claim 1;
supplying the first and/or second and/or further position data to a controller for controlling the wind turbine based on the first and/or second and/or further position data.

14. A device for performing deformation and/or orientation analysis of a wind turbine rotor blade, the device comprising:
a mounting frame to be mounted at a wind turbine blade;
a first navigation system probe fixed to the mounting frame;
in particular a second navigation system probe fixed to the mounting frame;
wherein when the mounting frame is mounted at the blade such that:
the first navigation system probe provides position at a first location;
the second navigation system probe provides position at a second location.

15. A rotor blade system, comprising:
a rotor blade for a wind turbine;
a device according to claim 14, mounted at the rotor blade.
